(19) United States
(12) Patent Application Publication
(10) Pub. No.: US 2009/0218339 A1
(43) Pub. Date: Sep. 3, 2009

(54) Applique microwave oven leakage seal

(76) Inventor: Martin Paul Lepselter, Summit, NJ (US)

Correspondence Address: Martin P. Lepselter, 25 Sweetbriar Road, Summit, NJ, 07901, US

(21) Appl. No.: 12/290,390

(22) Filed: Oct. 31, 2008

Related U.S. Application Data
(60) Provisional application No. 61/067,425, filed on Feb. 29, 2008.

(51) Int. Cl. H05B 6/76

(52) U.S. Cl. 219/741

(57) ABSTRACT

This invention relates to a method for producing a low-cost solution to the problem of radiation leakage that escapes from modern microwave ovens due to the door cracks that form in the under-size bezels used in today's microwave oven market. The appliqué structure of the Patent includes a ⅛ inch diameter copper wire that is used to terminate the field lines of any escaping radiation thus preventing leakage beyond the oven itself.

The present patent application relates to my U.S. Provisional Patent Application No. 61/067,425, filed on Feb. 29, 2008, and entitled “Appliqué Microwave Oven Leakage Seal”.

### FIELD OF THE INVENTION

The present invention relates generally to microwave ovens, and more particularly, to an arrangement to substantially reduce microwave radiation leakage through cracks that form in the under-size bezel portions of microwave ovens.

### BACKGROUND OF THE INVENTION

Microwave ovens are usually fabricated with a seal along the opening of the oven cavity to prevent microwave radiation-from leaking out of the oven. This seal must be efficient since present day regulations limit the allowable leakage out of the oven cavity.

Modern ovens are fabricated with thin bezels in order to save money. Because of this trend these thin bezels are prone to breakage along the bottom edge of the door. A simple closing of the door with moderate speed can cause a crack along the edge of the oven door, especially along the bottom edge which is particularly vulnerable to cracking, clean-through the bezel.

There has been almost no work done to repair a radiation-leaking door seal that has become ineffective except by replacing said door, a very expensive solution which can cost almost as much as the oven itself did originally. This invention is allows one to repair the seal with minimal cost and effort, and the repair can even be done by the average homeowner.

### SUMMARY OF THE INVENTION

A main object of the present invention is to provide a repaired microwave seal to a damaged-bezel microwave oven. This allows one to keep his present oven by repairing the damage to said bezel at low-cost and effort.

A further object of the present invention is to provide for a thin metallic substrate having adhesive means on one of the two major parallel surfaces.

Another object of the present invention is to provide a metallic wire positioned along the longitudinal edge of said substrate wherein an end section of said substrate wraps circumferentially around said wire thereby flexibly holding together said wire and substrate.

A further object is to present a sealing arrangement wherein the thin elongated metallic substrate comprises an aluminum foil that is adhesively bonded to the vertical edge of said bezel.

These objects or achieved by a device and the method having the features this defined in these claims.

### BRIEF DESCRIPTION OF THE DRAWINGS

Further features and advantages of the present invention will become apparent from the following detailed description taken together with the drawings in which:

FIGS. 1A and 1B show the microwave oven according to a preferred embodiment and its bezel.

FIGS. 2A and 2B show further views with the oven door open.

FIG. 3 shows an enlarged view of the area where the door meets the oven body itself. The slit which may leak radiation when enlarged this shown.

FIG. 4 shows a picture of the electric field lines in a metal structure with holes and a slit

FIG. 5 shows the applique structure of the Patent whereby the ⅛ inch diameter copper wire is used to terminate the field lines of any escaping radiation thus preventing leakage beyond the oven itself.

FIG. 6 shows a plot of the electric field intensity vs the distance from the slit.

### DETAILED DESCRIPTION

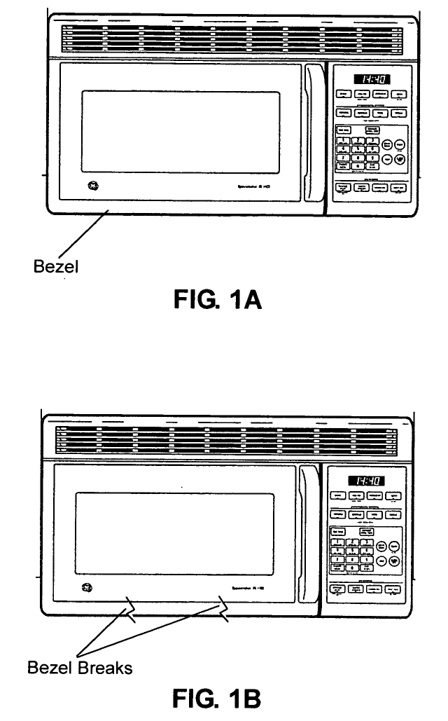

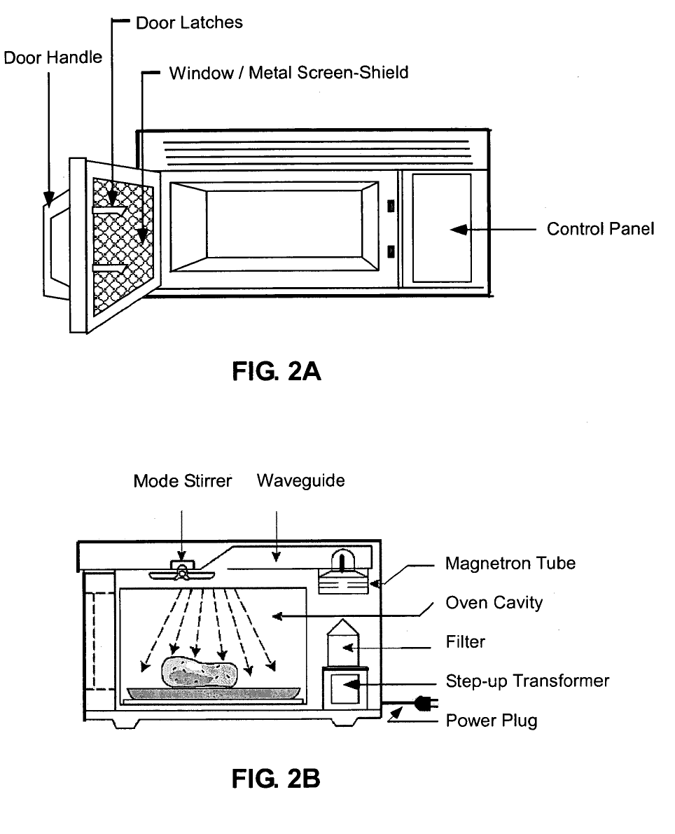

FIGS. 1A and 1B show a front view of a typical over-the-range microwave oven showing the bezel surrounding the door. FIG. 1B shows the cracks forming in the bezel after closing the door with a moderate force. These cracks lead to a poor fit into the latches shown in FIG. 2A. This poor fit leads to excess microwave leakage through the enlarged slit width.

FIGS. 2A and 2B show the previously described microwave oven. FIG. 2A shows the oven with the door open. The door latches and the window screen may be seen in this figure. FIG. 2B is a schematic drawing of the oven showing the different parts making up the system above

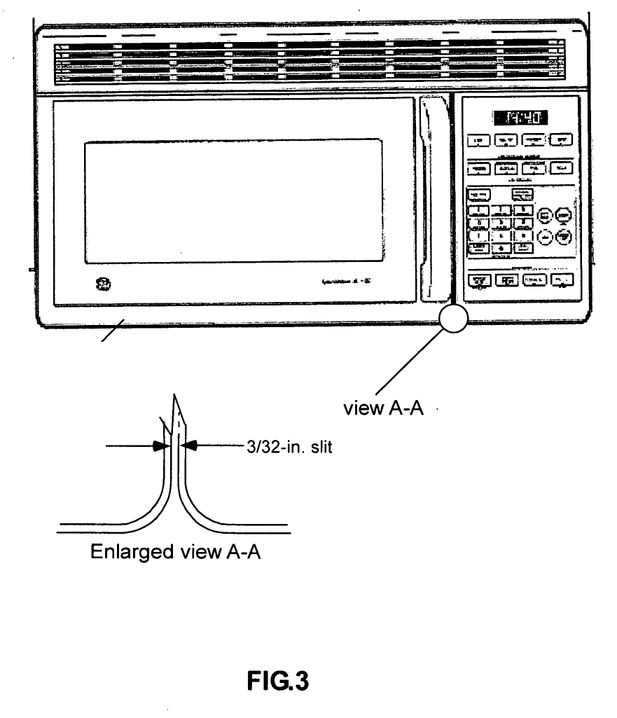

FIG. 3 shows an enlarged view of the area where the door meets the oven body itself. One can see the slit which is formed by the clearance needed for the door to open. Note that when the bezel has cracks the slit widens and allows excess radiation to leak from the slit. This radiation may take the form of evanescent waves in addition to remarkable zero order resonant transmission into a single sub wavelength metal slit as proposed by J. R. Suckling and J. R. Samles in Physical Review Letters of Oct. 28, 2005. Other modes of radiation may also be stimulated (e.g., Fabry-Perot excitation). Nevertheless, thousands of people feel they are being exposed to this excess radiation and this Patent is meant to assuage their fears.

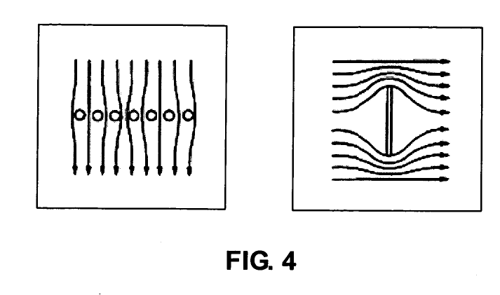

FIG. 4 shows the field lines in the metal structure of the set of holes on the left and the slit on the right. One can see that the holes like those in the viewing screen in the door itself are very effective in shielding the oven from leakage. The slit itself is not nearly as efficient as a radiation stopper. This Patent overcomes the deficiency.

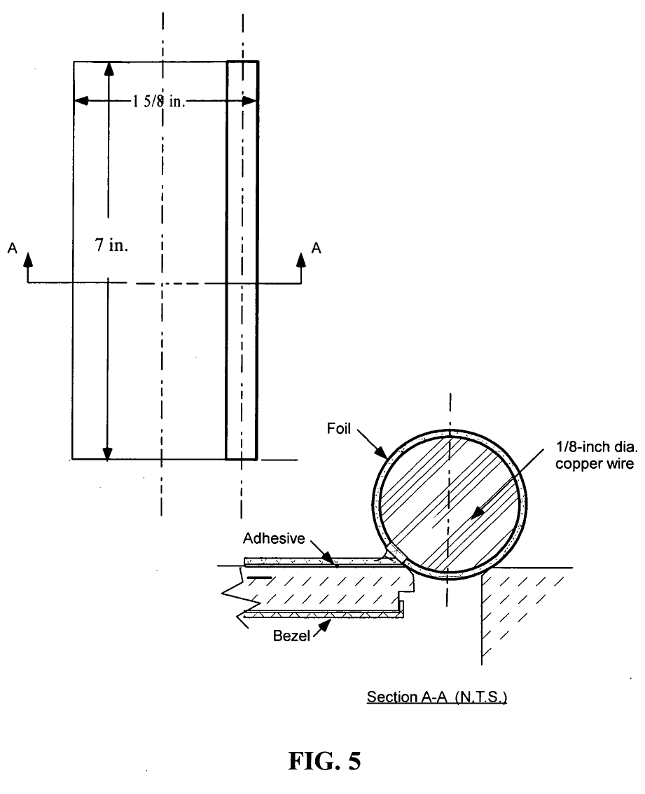

FIG. 5 shows the appliqué structure. The plan view shows the metal foil after having been appliqued to the area under the door handle and covering the slit between the door edge and the microwave oven body. The foil is wrapped circumferentially around the piece of ⅛ inch diameter copper wire. This wire serves the purpose of terminating the electric field of any electric field lines which might otherwise escape. This wire may be subsequently gently nudged into the slit after the appliqué. The surface area exposed is not an adhesive covered area and thus can be readily manipulated. A preferred aluminum foil is three and a half mils thick and has an acrylic adhesive. This type of foil is specially designed to seal against moisture and vapor over a wide temperature range, and is widely available commercially.

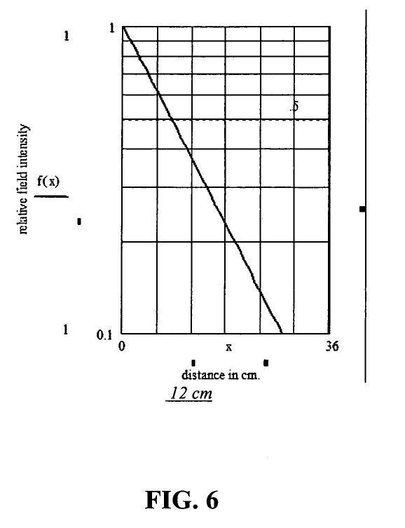

FIG. 6 shows a plot of the intensity of the electric field vs. the distance from the slit. This figure represents the vector height of the simple intensity of the evanescent waves as it decays into the room. Were this the only radiation there would be no consumer outcry.

It is understood that the above described process or structure is simply illustrative of the many possible specific applications of the invention. For example, the adhesive backed foil may be easily replaced with plain aluminum foil and glued down. Numerous and various modifications may be made by one skilled in the art without departing from the spirit and scope of the invention.

1. A sealing arrangement for reducing and/or eliminating microwave radiation comprising:
a thin elongated metallic substrate having adhesive means on one of its two major parallel surfaces; and
a metallic wire positioned along a longitudinal edge of said substrate wherein an end section of said substrate wraps circumferentially around said wire thereby flexibly holding together said wire and substrate.

2. A sealing arrangement according to claim 1, wherein said thin elongated metallic substrate comprises an aluminum foil.

3. A sealing arrangement according to claim 1, wherein said adhesive means comprises an acrylic material.

4. A sealing arrangement and according to claim 1 wherein said metallic wire comprises a copper wire having the diameter of the order of ⅛ inch.
